(19) United States
(12) Patent Application Publication
(10) Pub. No.: US 2019/0335800 A1
(43) Pub. Date: Nov. 7, 2019

(54) Hemp Protein and Use for Microencapsulation

(71) Applicant: POS Management Corp., Saskatoon (CA)

(72) Inventors: Anusha Geethangani Perera SAMARANAYAKA, Saskatoon (CA); Udaya Nayanakantha WANASUNDARA, Saskatoon (CA); Moumita RAY, Saskatoon (CA); Richard Christopher GREEN, Saskatoon (CA)

(73) Assignee: POS Management Corp., Saskatoon (CA)

(21) Appl. No.: 16/405,741

(22) Filed: May 7, 2019

Related U.S. Application Data
(60) Provisional application No. 62/668,102, filed on May 7, 2018.

(51) Int. Cl. A23P 10/35; A23J 1/14

(52) U.S. Cl. CPC A23P 10/35; A23J 1/14

(57) ABSTRACT

Hemp seed protein fractions are provided with particular applicability for forming stable emulsions for microencapsulating lipid based components. The hemp seed protein fraction is extracted from a hemp seed protein source by aqueous alkaline extraction, followed by separation to provide a aqueous hemp protein solution and residual hemp protein source solids. The hemp seed protein fraction is isolated from the aqueous hemp protein solution by either i) precipitating hemp proteins from the separated aqueous hemp protein solution at or above the isoelectric pH and at a temperature no greater than 70° C., and separating the precipitated proteins to produce a hemp seed protein fraction; or ii) ultrafiltering the separated aqueous hemp protein solution to produce a hemp seed protein fraction having a molecular weight of 5,000 Da and higher. The isolated hemp seed protein fractions form stable emulsions with lipid based components and form microencapsulated powders.

### CROSS REFERENCE TO RELATED APPLICATIONS

This application claims priority from U.S. Provisional Patent Application No. 62/668,102 filed May 7, 2018, which is incorporated by reference herein to the extent that there is no inconsistency with the present disclosure.

### FIELD OF THE INVENTION

The invention relates to extraction of hemp protein product from hemp sources, novel hemp protein products, and microencapsulation of oils using same.

### BACKGROUND

Microencapsulation is a technology to isolate or embed liquid substances and/or other ingredients in a solid physical barrier or in a solid homogeneous or heterogeneous matrix to produce small capsules with various morphologies and of diameters between 0.2 and 5,000 microns. The encapsulated substances are known as the core, internal or payload phase and the outer protective materials are considered as the wall, external or coating phase. In recent years, microencapsulation has become a popular and important technology for the delivery of numerous ingredients in food matrices. Commonly explored microencapsulation techniques are spray-drying, single- or multi core-coacervation, spray chilling/coating and extrusion. The main focus is to encapsulate a wider range of labile food ingredients (heat, moisture & oxygen sensitive ingredient) with low operational cost for improved shelf-life. Among all the techniques, spray drying is a commercially useful microencapsulation method, where liquid oils (e.g., omega-3 oil, flavor oil) are first converted to an emulsion form and then into dried powders using proteins and/or carbohydrates as wall matrix materials. To improve the quality of the final spray dried powder, it is important to choose an effective encapsulating wall material to increase the labile oil loading, control particle size inflation at spray drying stage and avoid a high level of (extractable) surface oil to retard rancidity and off flavor of the final products.

The use of vegetable proteins as a wall material for microencapsulation is of interest as “green” ingredients in the food, pharmaceutical, and cosmetic industries. U.S. Pat. No. 9,332,774 to Nakhasi et al. describes microencapusulated oil products and their preparation, and includes background on other microencapsulation techniques. In general, protein isolates such as whey, soy, and other vegetable proteins as well as their fractions have been tested for their ability to act as carriers for encapsulating different active biomaterials, including oil.

### SUMMARY

In one broad aspect, the invention provides a microencapsulated product of microcapsules, wherein the microcapsules include:

(a) a core comprising a lipid based component; and

(b) a coating comprising a hemp seed protein fraction obtained by alkaline aqueous extraction from a hemp seed protein source such that the hemp protein fraction is water soluble under alkaline conditions and is capable of forming a stable emulsion.

In some embodiments, the hemp seed protein fraction is water soluble at a pH range of 8.5 to 11.5, or 9 to 11. In some embodiments, the hemp protein fraction has a molecular weight in the range of 5,000-500,000 Da, or 10,000-500,000 Da. In some embodiments, the hemp protein fraction for the coating is isolated from an aqueous solution of the hemp seed protein source by precipitating at or above an isoelectric pH of the hemp protein and at a temperature less than 70° C., or by ultrafiltration from an aqueous solution of the hemp seed protein source.

In another broad aspect, the invention provides a method of extracting a hemp seed protein fraction including:

a) providing a hemp seed protein source;

b) contacting the hemp seed protein source with an alkaline aqueous solution to extract hemp protein from the hemp seed protein source into an aqueous hemp protein solution;

c) separating the aqueous hemp protein solution from residual hemp protein source solids; and

d) isolating a hemp seed protein fraction by either:
i. precipitating hemp proteins from the separated aqueous hemp protein solution at or above an isoelectric pH of the hemp protein and at a temperature less than 70° C., and separating the precipitated proteins to produce the hemp seed protein fraction; or
ii. ultrafiltering the separated aqueous hemp protein solution to produce the hemp seed protein fraction having a molecular weight of 5,000 Da and higher.

In some embodiments of the method of extraction, the pH of the extraction in step b) is in the range of 8.5-11.5, or 9-10. In some embodiments of the method, the hemp protein fraction is produced by step d, i) at a pH in the range of 4.5-5.5. In some embodiments of the method, the hemp protein fraction is produced by step d, ii).

In some embodiments, the method of extraction is followed by one or both of the steps of:

e) forming a stable emulsion of the hemp seed protein fraction with a lipid based component; and.

f) drying the stable emulsion to form a microencapsulated product of microcapsules having a core comprising the lipid based component and a coating comprising the hemp seed protein fraction.

The invention also broadly extends to a hemp seed protein fraction for use in microencapsulating a lipid based component, wherein the hemp protein fraction is obtained by alkaline aqueous extraction from a hemp seed protein source such that the hemp protein is water soluble under alkaline conditions and is capable of forming a stable emulsion with a lipid based component.

### BRIEF DESCRIPTION OF THE DRAWINGS

FIG. 1 is a flow chart of one embodiment of a pilot plant scale operation for extracting a hemp protein fraction having a molecular weight of 5,000 Da and higher.

FIG. 2 is a flow chart of one embodiment of a pilot plant scale operation for microencapsulating hemp seed oil with a hemp protein fraction of this invention.

FIG. 3 is a flow chart of one embodiment of microencapsulating hemp seed oil using a hemp protein fraction of this invention and maltodextrin.

FIGS. 4-7 are particle size distribution analysis for microencapsulated powders, showing microencapsulation with either the hemp protein fraction alone (FIGS. 4 and 6), or with the hemp protein fraction with polysaccharide (FIGS. 5 and 7), as discussed in Example 2. The hemp oil payload was 50% in FIGS. 4 and 5, while the hemp oil payload was 30% in FIGS. 6 and 7. The extraction and microencapsulation processes were as shown in FIGS. 1-3, and more fully described in Example 2.

FIG. 8 illustrates Scanning Electron Microscope (SEM) images of microencapsulated hemp seed oil at a 50% payload in a hemp protein product fraction alone (top two images), or in a blend of that hemp protein fraction and maltodextrin (bottom two images). The extraction and microencapsulation processes were as shown in FIGS. 1-3, and more fully described in Example 2.

FIG. 9 is a flow chart of one embodiment of a process for extracting hemp seed protein fraction followed by acid precipitation to produce a hemp protein for use in microencapsulation.

### DETAILED DESCRIPTION

Certain terms used herein and in the claims are defined and clarified hereinbelow.

“Hemp” includes all species of the Cannabis plant genus, including without limitation Cannabis sativa, Cannabis indica, and Cannabis ruderalis.

“Hemp seed protein source” includes hemp seed and other protein rich components of hemp seed such as de-hulled hemp meal and hemp hulls, as well as screened hemp meal fractions and hemp flour or hemp powder. These hemp seed protein sources are preferably pressed and may be defatted.

“Emulsifying Capacity” (EC, g oil/g protein), refers to the amount of oil that can be emulsified by a standard amount of protein under a specific set of conditions. While standard tests exist to measure EC, the following test is used herein to measure EC:

1. Prepare a 1% (w/w) protein solution in 10 mM sodium phosphate buffer (pH 7.00; adjusted with either 0.1 M NaOH or 0.1 M HCl) followed by stirring at 500 rpm overnight (˜16 h) at 4° C.

2. Prepare a series of emulsions with different oil percentages by adding X grams of vegetable oil to Y g of the protein solution in a 50 mL screw capped centrifuge tube.

3. Homogenize at 16,000 rpm for 5 min using a Polytron homogenizer (Position the blade at the oil-water interface prior to homogenization).

4. Immediately measure emulsion conductivity using a conductivity meter. Conductivity measurement experiences a significant drop as the emulsion inverts from an oil-in-water emulsion to water-in-oil. Emulsion capacity is expressed as grams of oil homogenized per gram of protein before the inversion was observed.

“Emulsion Stability” (ES, %), refers to the stability of an emulsion against phase separation after 30 minutes of holding at ambient conditions after homogenization. While standard tests exist to measure ES, as used herein to refer to the ability of a protein fraction to form a “stable emulsion”, a value of ES greater than 80% indicates the ability to form a “stable emulsion”, and a value of 90% without visible phase separation being most preferred, with the following test being used to measure ES:

1. Prepare an oil-in-water emulsion by homogenizing 5 mL of 1.0% protein solution (w/w) and 5 mL of vegetable oil in a 50 mL centrifuge tube at 16,000 rpm for 5 min using the Polytron homogenizer.

2. Emulsions are then quickly transferred to a 10 mL graduated cylinder immediately after preparation.

3. The stability of the emulsion is monitored by observing the separation of a serum layer after 30 min of storage at room temperature. At this point, emulsions may separate into an aqueous layer (bottom) and a turbid layer at the top with a similar appearance to the original emulsion. Emulsion stability (ES) is expressed as ES (%)=(VB-VA)/VB×100, wherein VB is the volume of the aqueous phase before emulsification (10 mL) and VA is the volume of the aqueous (or serum) layer after 30 min of storage.

“Isoelectric pH” when used for protein precipitation techniques is the pH at which the protein molecules have a net zero charge and, therefore, precipitate out of a solution.

“Oil payload”, sometimes referred to as oil loading, denotes the amount of oil that can be incorporated in forming microcapsules without having significant oil on the microcapsules, relative to the total weight of the microcapsules, based on the dry weight of the microencapsulated product.

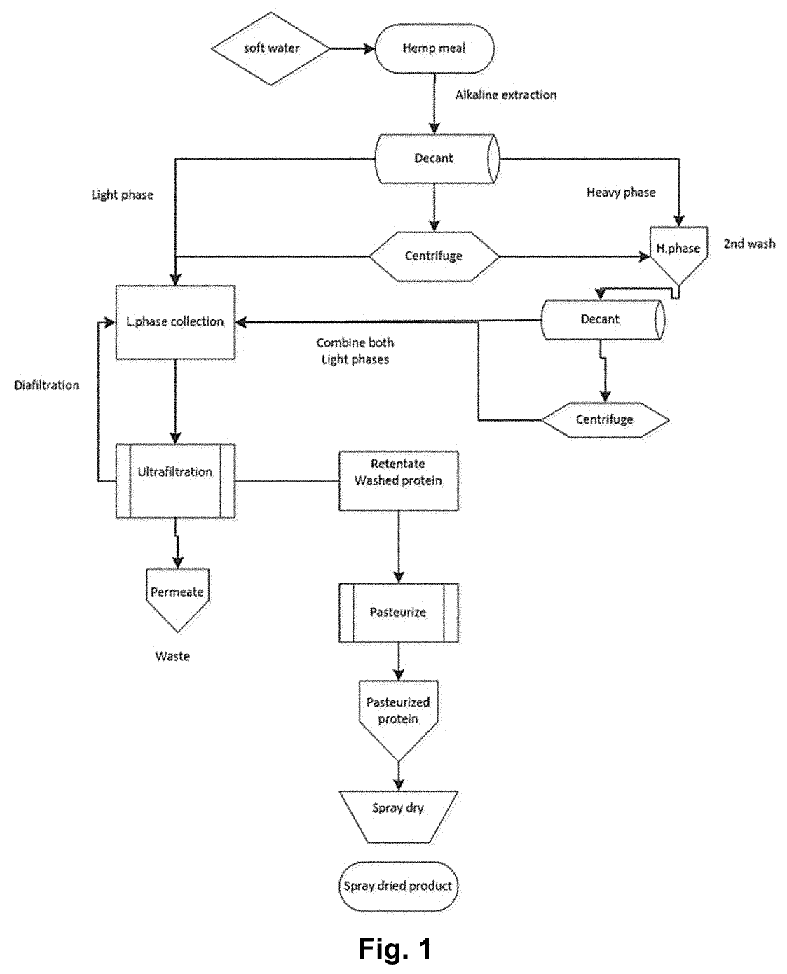

The hemp protein fraction is produced from hemp seed press cake whereby the protein in the press cake is extracted in an aqueous alkaline solution, with one embodiment being shown in FIG. 1. The protein is solubilized (i.e., extracted) from a hemp seed protein source, such as defatted hemp seed (hemp seed press cake) or non-defatted, de-hulled hemp meal and hemp hulls. In some embodiments, the hemp seed press cake is treated by alkaline extraction, for example at a pH ranging in pH from 7.5 to 12.0, such as 7.5 to 11.5, or 8.5 to 11.5, or 9.0 to 11.0, and at temperatures to avoid damaging heat labile proteins, for example at mild temperatures not greater than 70° C., for example ranging from 15 to 60° C., or more preferably from 30 to 50° C. The hemp seed protein solution is then separated from the hemp seed press cake insoluble solids, for example by centrifuging, decanting, screening or filtering. With non-defatted press cake, oil removal during protein extraction is achieved using a cream separator or a desludger centrifuge set up as a three-phase (solid/liquid/liquid) or a two-phase (liquid/liquid) separator.

In some embodiments, such as shown in FIG. 1, proteins included in the hemp seed protein solution are fractionated by membrane ultrafiltration to produce a protein fraction having a molecular weight higher than 5,000 Da, preferably higher than 10,000 Da, for example ranging in molecular weight range of 10,000 to 500,000 Da. The preferred conditions for ultrafiltration include alkaline pH, such as pH 10-11, or 10.5-11, and mild temperatures, such as 15-60° C. The protein fraction is generally washed and pasteurized, and the pH neutralized. Pasteurization conditions include heat treatment at high temperatures for a brief time period, for example 72-74° C. for 20-24 seconds. For subsequent microencapsulation, the resulting protein fraction can be used in the water-based solubilized fraction or dried to a powdered protein fraction. In some embodiments, silica can be added to the protein fraction in solution prior to drying to enhance flowability of the dried protein powder.

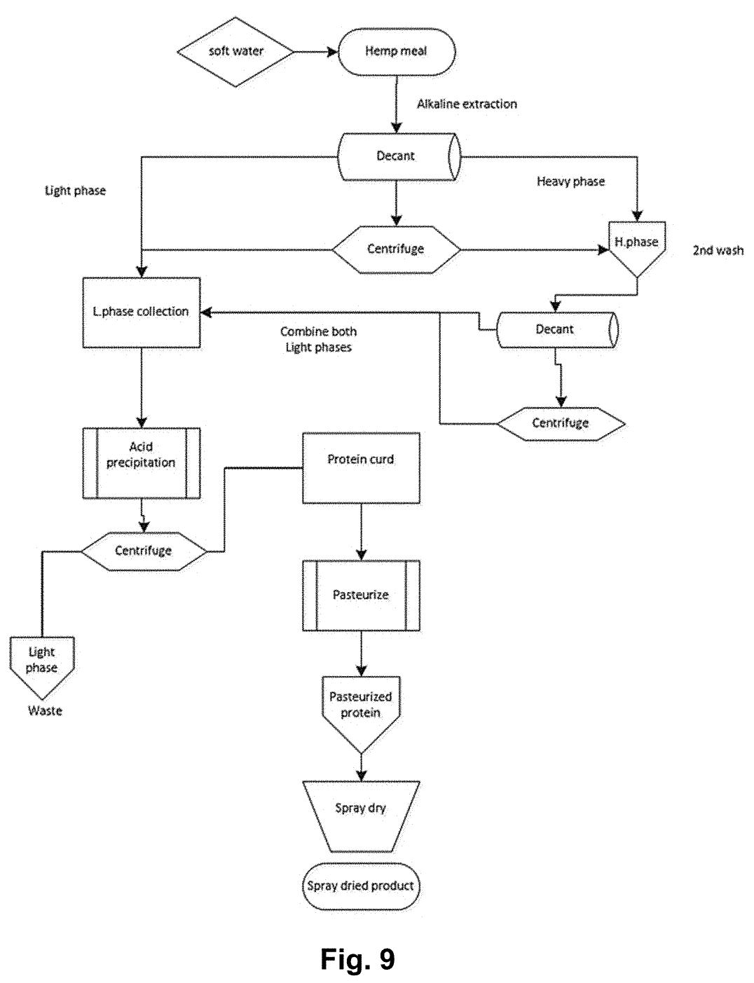

In some embodiments, such as shown in FIG. 9, proteins in the hemp seed protein solution are precipitated, for example by acid precipitation at or above the isoelectric pH, for example at a pH in the range of 4.5 to 6, or 4.5-5.5, such as pH 5. Exposure to acid conditions below the isoelectric pH, such as below pH 4.0, should be avoided. Similarly high temperatures during acid precipitation should be avoided, such as temperatures above 70° C. for more than one minute. Acids used are generally food grade acids such as phosphoric acid or hydrochloric acid. The resulting hemp protein is generally pasteurized before microencapsulation, for example at 72-74° C. for 20-24 seconds. For subsequent microencapsulation, the hemp protein product may be used as a water-based solubilized product, or dried to a powdered protein product.

The hemp protein fraction may be used in dried form or wet, aqueous form, depending on the application. The hemp protein product extends to a hemp protein concentrate of 40 to 80% (w/w) purity and a hemp protein isolate of greater than 80% purity.

The hemp seed protein fraction may also be treated using absorbents or chemicals to remove colour and flavour from the protein. The hemp seed protein fraction may be treated by selective heat or chemical modification to modify the functionality of such protein. Alternatively, the hemp seed protein fraction may be modified by controlled enzyme hydrolysis, for example with Bromelain, followed by heat inactivation of the enzyme.

The inventors have demonstrated that the above-described hemp seed protein fractions have particular utility for microencapsulating lipid based components. Exemplary lipid based components include edible oils, essential oils, waxes and flavours. The lipid based components may include other bioactive components. For example, edible oils may be derived from one or more of an oilseed crop, cereal crop, legume, algae, microalgae, fish and yeast. Particularly useful edible oils are derived from one or more of hemp seed, canola, flax, microalgal, soybean, oat, chickpea, camelina, coconut, and fish. Such oils may also be blended. The oils may be crude pressed, crude solvent extracted, or refined, bleached, and deodorized, processed oils.

The inventors have established through experiments that the hemp seed protein fraction is useful in providing microencapsulated products in which the lipid based component comprises greater than 10% by weight of the microencapsulated product in a dry powder form. Oil loading greater than 30% by weight, such as 35%, 50% and 70% oil payloads have been achieved with the hemp protein fraction.

In general, microcapsules are prepared by solubilizing the above-described hemp protein fraction in water (or providing the fraction in its wet, aqueous form following extraction), adding the oil, or other lipid based component, to the solution, homogenizing in one or more steps to provide a stable emulsion, for example by passing the mixture through a high pressure homogenizer, and spray drying the microcapsules into a stable powder. Methods of microencapsulating, emulsifying agents and additives for microencapsulating are well known, such as taught in U.S. Pat. No. 9,332,774 to Nakhasi et al., and in the references referred to therein. The invention extends to microencapsulation processes and products with coatings formed with the novel hemp seed protein fractions of this invention, whether the hemp product is used alone as the coating material, or with other carbohydrate ingredients and additives in the coating, or as double layer microcapsules.

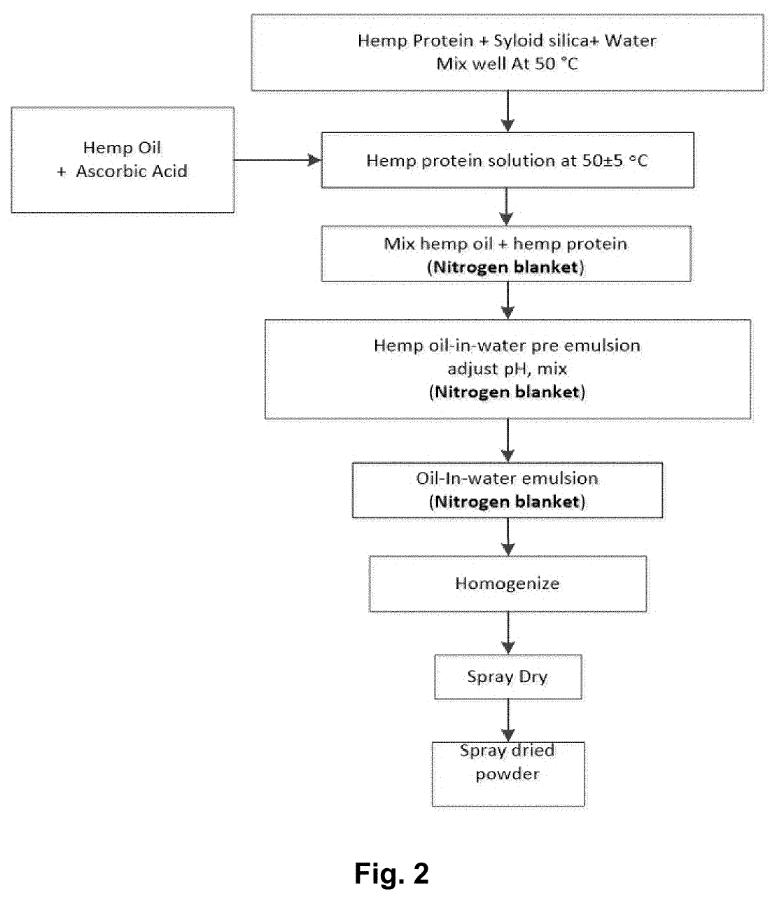

In one embodiment, and as shown in FIG. 2, microencapsulation of a core lipid, such as hemp oil, is prepared by first dissolving the dried hemp seed protein fraction in water. Heat may be applied up to about 55° C. to facilitate dispersion and solubilization of the hemp protein fraction. Once the hemp protein is dissolved, the hemp oil, together with any additives such as oxidation inhibitors (ex. ascorbic acid), are mixed into the water protein solution and homogenized to form an emulsion or a pre-emulsion. Homogenization uses a high speed homogenizer (ex. above about 15,000 RPM) and/or a high pressure homogenizer, and homogenization may take place in multiple steps, for example by forming a pre-emulsion followed by further homogenizing in a high pressure homogenizer. In FIG. 2, the process is shown with the formation of a pre-emulsion. The pH of this pre-emulsion is adjusted to a pH ranging from 3.0 to 10.0, such as 6.0 to 8.0, or 8.0. The pH for a stable emulsion varies with the oil being encapsulated. For hemp seed oil, stable emulsion can be formed in the pH range 6-10 with hemp seed protein fractions of this invention, with pH 8.0 generally forming the most stable emulsion. The mixture is then homogenized in a high-pressure homogenizer at 5,000 to 30,000 psi, or 10,000 to 30,000 psi, to produce an emulsion whereby protein solution entraps the oil droplets. The emulsion can then be spray dried to a powder form whereby the oil is encapsulated by the hemp protein fraction.

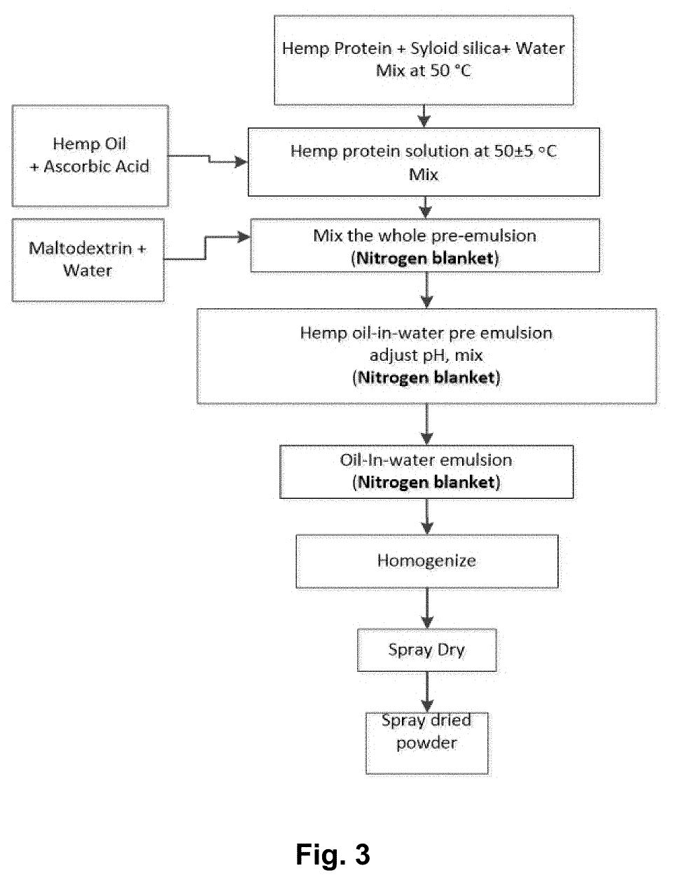

In another embodiment, microencapsulation is enhanced by adding a polysaccharide such as maltodextrin, after the hemp protein solution has been mixed with hemp oil, as shown in FIG. 3. The polysaccharide mixture is then prepared by homogenizing, adjusting to a pH ranging from 3.0 to 10.0, such as 6.0 to 8.0, or 8.0, where the most stable emulsion is formed with hemp seed oil. The mixture is high pressure homogenized to prepare a fine, stable emulsion of small encapsulated oil droplets and the emulsion is spray dried to produce a powdered microencapsulated oil. Alternate polysaccharides that may be used include gums/hydrocolloids such as gum arabic, gelan gum, and carageenan, starches or modified starches from cereals, pulses, and root crops such as rice, wheat, oat, pea, alginates, isomaltooligosaccharides, lactates, and soluble fibers. Other emulsifiers such as phospholipids and mono- and di-acylglycerols may be used.

The microencapsulated oil product is useful in a free-flowing powder form, with good wettability and with good shelf life. When the core is an edible oil, the microencapsulated product can be used in a variety of food and beverage products such as dry beverage mixes, sport drink mixes, milk-based powdered drink mixes, powdered or liquid infant formulas, powdered or liquid gravies and sauces, in baked goods or mixes, confectionery items, and snack bars. The nutritional benefit of the oil core is retained in the microcapsule. As well, the consumer receives the additional nutritional benefit from the hemp protein portion of the microcapsules. Depending on the nutritional benefits of microencapsulated oil, the microencapsulated products may provide a useful energy source, an anti-inflammatory effect, blood pressure regulation, cholesterol reduction and weight control.

The present invention is further illustrated by the following non-limiting examples. In these examples, and in other experimental work by the Applicant, the hemp seed varieties utilized included Picolo, Katani and Grandi developed by Hemp Genetics International, Saskatchewan, Canada, and X-59 and Finola varieties provided by the Canopy Growth Corporation, Ontario, Canada. The varieties belong to the species Cannabis sativa L. Based on Applicant's extensive experience, the seeds of other botanically related Cannabis plant species predictably have similar chemical and functional attributes in the protein extracted, and as such, the protein of other species of the genus Cannabis, including without limitation Cannabis indica, Cannabis ruderalis, predictably have similar protein attributes to the Cannabis sativa protein of these examples. Such Cannabis species also include varieties of Cannabis sativa and Cannabis indica that contain higher concentrations of the psychoactive component tetrahydrocannabinol, commonly found in the marijuana varieties of Cannabis.

Analytical testing proceeded as follows:

| | Analysis Reference |
|---|---|
| Protein (Nx6.25) | AOCS Ba 4e-93 |
| Oil content by Swedish tube | Internal Method |
| Ash | AOCS Bc 5-49 |
| Moisture and volatiles | AOCS-Ba 2a-38 |
| Carbohydrates (calculated) | Internal Method |
| Amino acid profile | Waters Pico-Tag Method |
| | and Internal Method |
| Protein Dispersibility Index (PDI) | AOCS Ba 10a-65 |
| Crude fiber | AOCS Ba 6a-05 and |
| | Ankom Method 10 |
| Fatty acid composition | AOCS Ce 1i-07, |
| | AOCS Ce 1b-89 |
| Free fatty acids/acid value | AOCS Ca 5a-40 |
| Peroxide value | AOCS Cd 8b-90 |
| Anisidine value | ISO/CD 6885.2 |
| Tocopherols profile | Internal Method |
| Gardner colour | AOCS Cc 13j-97, |
| | (AOCS Td 1a-64) |
| Functionality testing: | Internal methods |
| Solubility, emulsifying capacity (see above) | |
| and emulsion stability (see above), foaming | |
| capacity and foam stability, least gelation | |
| concentration, oil holding capacity, water | |
| hydration capacity | |

### EXAMPLES

### Example 1

### Pilot Scale Production of Hemp Protein Product and Microencapsulation

About 1500 kg of organic Picolo hemp seed were cold pressed and press cake was solvent extracted with isohexane using a pilot scale solvent extractor to obtain the defatted meal for protein extraction work. Defatted meal was dried using a vacuum dryer at 50-55° C. to remove residual hexane. This meal was milled further to a fine powder using a Hammer mill (Prater Industries Inc., Chicago, Ill.) with a 1/20^{th} inch screen.

Filtered oil obtained from pressing and the solvent extracted oil were combined, refined (R) and bleached (B) using conventional industry standard processing protocol to produce an RB oil for encapsulation purposes. Press cake and defatted meal was analyzed for proximate composition and the filtered and RB oil were analyzed for fatty acid composition. Peroxide and p-anisidine values and tocopherol profile of RB oil was also assessed.

A. Pilot Trial 1—Protein Isolate Production Through Isoelectric Precipitation

Defatted and milled hemp meal (300 kg) was used for the first pilot scale trial in producing a protein isolate. Alkaline extraction was at pH 11, 40° C. for 2 hr. A decanter centrifuge (CA225-010, Westfalia Seperator AG, D-59302 Oelde, Postfach 3720) followed by a desludger centrifuge (Westfalia SA14-02-076, CENTRICO INC., Northvale, N.J.) was used to collect the protein extract as the aqueous solution (light phase) and the insoluble solids (heavy phase) were used to re-extract and collect more proteins. Extraction was repeated for another 1 hr (pH 11, 40° C.) by adding 2 parts (w/w) of water to the spent solids obtained from the first extraction. Initial efforts to concentrate the combined extract light phases and ultrafilter to recover proteins in the retentate indicated that temperatures above about 70° C. were problematic, as some proteins precipitated due to possible heat denaturation during the concentration process. The proteins in the light phase were concentrated using a vacuum evaporator and were precipitated isoelectrically, by adjusting the pH to 4.5 using 85% phosphoric acid. Precipitated protein was recovered by centrifugation, washed, pasteurized (72-74° C. for 22-24 seconds), neutralized to pH 7.0 using 50% potassium hydroxide, and spray dried to obtain the hemp protein powder. This protein fraction was labelled as DF Picolo-PTP-1. Proximate composition, protein dispersibility index, amino acid composition, and functional properties of the protein were assessed. Defatted meal was also tested for composition and amino acid content.

B. Pilot Trial 2: Protein Isolate Production Through Ultrafiltration

A second pilot scale trial was conducted using another 300 kg of the defatted and milled hemp meal following the same alkaline extraction procedure as the Pilot Trial 1, avoiding the pre-concentration step with temperatures above 70° C. to avoid possible heat denaturation. Instead of acid precipitation of Example 1, the proteins were isolated as shown in FIG. 1. Pooled protein extract was concentrated using a set of 5 kDa ultrafiltration membranes (Millipore ProFlux M140 ultrafiltration system) to remove sugars, salt and lower molecular weight proteins, and then diafiltered to further remove lower molecular weight proteins, salts and sugars. The ultrafiltration step conditions were at pH 10.5-11 and less than 50° C. Collected retentate was neutralized to pH 7.0 using 85% phosphoric acid, pasteurized (72-74° C. for 22-24 seconds) and spray dried to obtain the hemp protein powder. This protein fraction was labelled as DF Picolo-PTP-2. Proximate composition, protein dispersibility index, amino acid composition, and functional properties of the protein were assessed.

C. Lab Scale Hemp Oil Encapsulation with DF Picolo-PTP-1 and DF Picolo-PTP-2

Protein powders made during this pilot work was used to make encapsulated powders at 30, 40 and 50% oil loading at lab scale first and the oil powders were assessed for the powder yield and surface oil content.

D. Pilot Trial 3: Encapsulated Hemp Oil Powder Production

Based on lab scale hemp oil microencapsulation work conducted using DF Picolo-PTP-1 and DF Picolo-PTP-2, a pilot scale trial of encapsulated powder production was performed to determine and validate the optimized processing conditions as well as to improve recovery with the developed formulation for 50% (w/w) hemp oil microencapsulated with DF Picolo-PTP-2 hemp protein fraction (83.7% protein purity, Protein Dispersibility Index (PDI) 76.9%) as the carrier. The RB hemp oil (original PV: 0.21 meq/Kg, p-Anisidine: 1.57) prepared from the pressed oil from same Picolo seed batch was used as the oil source. FIG. 2 shows the method used. Ten kilogram of hemp seed protein fraction and 0.2 kg of silica were mixed with water (230 kg) and stirred for 1 hr at 50° C. Hemp seed oil (10.3 kg) and ascorbic acid (0.02 kg) was added to the protein solution and homogenized well for 15 minutes using a power-in-line mixer to make the pre-emulsion. The pH of the emulsion was adjusted to the most stable condition (i.e., pH 8.0) and homogenized further at 15,000 psi using a microfluidizer (two passes) prior to spray drying.

Laboratory Scale Testing

Microencapsulation was done with an initial hemp oil-in-water emulsion formation at lab-scale with hemp seed protein fractions DF Picolo-PTP-1 and DF Picolo-PTP-2 and using the microfluidizer at 15,000 psi (two passes), followed by spray drying. The powder recovery and surface oil contents were assessed.

Six hemp oil powders were made using DF Picolo-PTP-2 protein fraction singularly or in combination with a polysaccharide blend at 30, 40, and 50% (w/w) oil loading. A schematic of the encapsulated powder formulation processes at 40% oil payload is shown in FIG. 3 for encapsulation with the DF Picolo-PTP-2 protein with maltodextrin. Hemp protein (165 g) was mixed with 6.4 g silica and 1.5 L water and stirred for 1.5 hr at 50° C. Hemp oil (176 g) and ascorbic acid (0.014 g) was added to the protein solution and homogenized using a polytron for 2 minutes to make the pre-emulsion. Maltodextrin (88 g) dissolved in 1 L of water was added to the protein-oil emulsion and homogenized for another 2 minutes. The pH of the emulsion was adjusted to the most stable condition (pH 8.0) and homogenized at 15,000 psi using a microfluidizer (two passes) prior to spray drying.

Variation of particle size distribution when DF Picolo-PTP-2 protein was used singularly or in combination with the polysaccharide was assessed at 50% and 30% oil payload. Further the variation of oil powder recovery and the surface oil content when preparing 40% oil payload RB hemp oil powders were assessed.

Particle Size Measurement

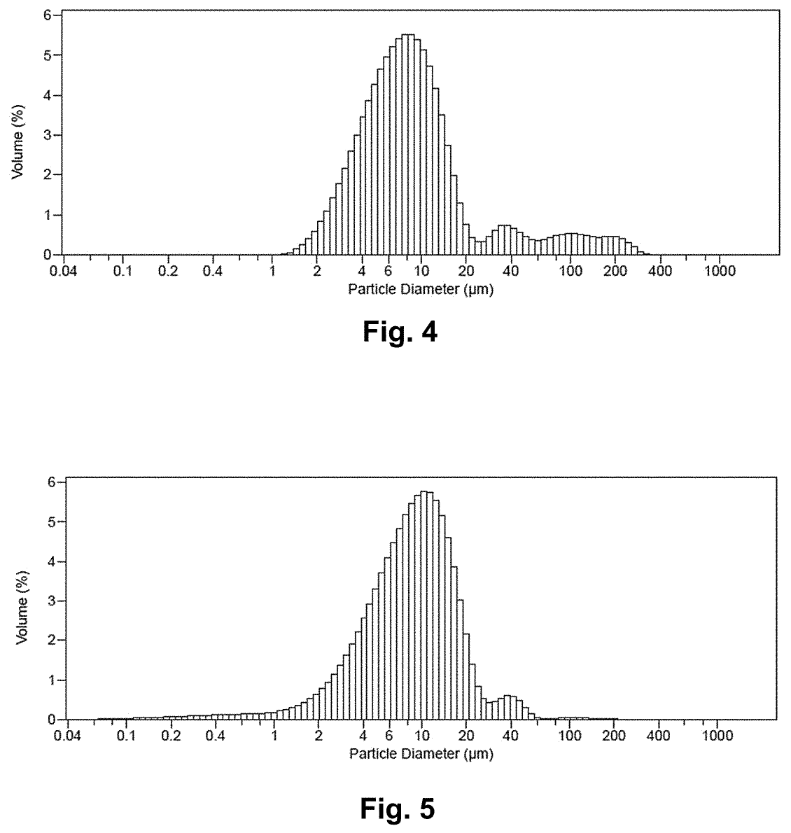

Laser light scattering experiments were conducted with Malvern Mastersizer 2000 with a Hydro 2000S wet cell attachment (Malvern Instruments, UK). Homogeneously dispersed spray dried powder in water was taken as a representative sample to analyze with Malvern Mastersizer 2000. Representative particle size distributions prior to visible sedimentation were reported. Distributions are shown in FIGS. 4-7.

Surface Oil Content Assessment

Surface oil content of the microencapsulated powder was determined on a sample of the spray dried powder. The powder was extracted for 10-15 seconds with a certain amount of petroleum ether. The petroleum ether was collected, filtered using a Whatman #3 filter paper, and the solubilized oil (surface oil) was quantified to determine the surface oil of the powder sample after removing the petroleum ether by rotary evaporation. The result was reported as a percentage base on the total oil present in the initial powder sample.

A scale up encapsulation process was performed using DF Picolo-PTP-2 protein fraction as shown in FIG. 2. Spray dried powder was characterized considering powder particle size distribution and by measuring of free fatty acid, peroxide value, and p-anisidine value contents. Oxidative stability of the microencapsulated hemp oil powder was also studied by monitoring powder shelf life for two months at ambient and accelerated (65° C.) temperature. Samples were analyzed each week. Hemp oil was first extracted from microencapsulated powders and the level of free fatty acid (FFA), peroxide value (PV) and p-anisidine values were determined. Similarly, RB hemp oil (as is) was also stored under similar conditions for two months and the oxidative stability was assessed every week for comparison.

Hemp Seed Pressing, RB Oil Production and Hemp Meal Defatting and Milling

Pressing of 1500 kg hemp seeds produced about 1022 kg pressed cake and 225 kg of filtered oil. Solvent extraction of press cake with isohexane recovered another 125 kg oil and produced about 819 kg of defatted and dried hemp meal. About 803 kg of milled hemp meal was recovered after Hammer milling and was used for protein extraction work.

Crude oil from pressing and solvent extraction (350 kg) was used to produce the RB oil (275 kg). Peroxide value and p-anisidine value of RB oil were 0.2 meq/kg and 1.57, respectively and the fatty acid composition is shown in Table 1.

According to literature, hemp oil contains high level of tocopherol, especially γ-tocopherol (˜700-900 ppm) that can act as an anti-cancer compound for colon cancers (Leizer et al. 2000). The α-tocopherol present (7-80 ppm) can also act as a natural antioxidant. The RB Picolo oil produced during this work was analyzed for tocopherol contents and showed that the oil contains 680 ppm of γ-tocopherol, 100 ppm of α-tocopherol, and total tocopherol content of 940 ppm.

TABLE 1
Fatty acid composition of pressed and RB Picolo hemp oil from
pilot scale

| | | Picolo | |
|---|---|---|---|
| Fatty acid (mg FA/g crude oil) | | Pressed and filtered oil | RB oil |
| C14 | Myristic | 0.4 | 0.4 |
| C16 | Palmitic | 53.4 | 50.8 |
| C16:In7 | Palmitoleic | 1.2 | 1.1 |
| C17 | Margaric | 0.5 | 0.5 |
| C18 | Stearic | 22.6 | 21.3 |
| C18:In9 | Oleic | 92.7 | 88.2 |
| C18:1 | Octadecenoic | 6.6 | 6.2 |
| C18:2 | Linoleic | 520.3 | 495.3 |
| C18:3n6 | G-linolenic (GLA) | 34.2 | 32.5 |
| C18:3n3 | α-linolenic (ALA) | 168.4 | 159.8 |
| C18:4 | Octadecatetraenoic | 12.4 | 11.7 |
| C20 | Arachidic | 8.3 | 7.7 |
| C20:1 | Eicosenoic | 4.3 | 4.0 |
| C20:2n6 | Eicosadienoic | 0.6 | 0.6 |
| C22 | Behenic | 3.4 | 3.2 |
| C22:1n9 | Erucic | 0.3 | 0.3 |
| C24 | Lignoceric | 1.5 | 1.4 |
| | Others | 2.7 | 1.8 |
| | Total fatty acids | 933.8 | 886.8 |
| | Total saturates | 90.1 | 85.3 |
| | Mono unsaturates | 105.1 | 99.8 |
| | Poly unsaturates | 735.9 | 699.9 |
| | Total omega 3 | 180.8 | 171.5 |
| | Total omega 6 | 555.1 | 528.4 |
| | Total omega 9 | 97.3 | 92.5 |

Hemp Seed Protein Fraction Production and Functional Characteristic Assessment

Proximate composition, protein dispersibility index (PDI), yields and amino acid composition of organic Picolo hemp seeds, meals and protein powders produced during pilot scale trials are shown in Tables 2 and 3. Using seeds with 24.5% protein content produced a press cake with 31.4% protein purity. About 9.4% residual oil remained in the press cake was removed through solvent extraction which produced a defatted meal with 44.8% protein. When one considers 18 primary amino acids, defatted hemp meal contained only 32.3% protein indicating presence of ˜12% non-protein nitrogen compounds. Total carbohydrate content as calculated accounted to about 43% indicating presence of soluble and insoluble fibers and sugars in the defatted meal.

During the first pilot scale trial, proteins were extracted under alkaline conditions. Hemp protein extractability and precipitation depend on pH. For example, lab trial indicated about 1.13% protein present in the light phase when extracted at pH 9.0, whereas the protein concentration in the light phase at pH 11.0 was 5.4%. During protein acid precipitation trials, it was evident that pH 5.0 produced a protein with the highest yield and purity, while pH 4.5-5.5 were the best range in precipitating a majority of the globular hemp proteins extracted under alkaline conditions. During the pilot Trial 1, combined protein extract after repeated extraction (˜3.1% solids) was concentrated at around 80-85° C. for a few minutes followed by at 55° C. for 20-30 minutes to obtain a concentrate with ˜10% solids. Without being bound by same, it is believed that exposure of the proteins to temperatures above 70° C. resulted in precipitation of some proteins (heat labile proteins), so should be avoided. The pH of the protein extract was then adjusted to its isoelectric point (4.5) to precipitate and recover the majority of the proteins for drying. Spray dried protein obtained had 81.9% protein (N×6.25), however, similar to the defatted hemp meal, amino acid analysis indicated that ˜11% of this protein value calculated using the 6.25 factor is actually non-protein nitrogen (Table 3). Precipitated protein also had ˜11% of ash and the PDI was only 10.2% indicating low dispersibility in water. Possible protein denaturation during pre-concentration plus protein aggregation during isoelectric precipitation can be the reason for this poor water dispersibility. Malomo and Aluko 2015 also reported limited solubility of acid precipitated hemp proteins.

During the second pilot trial, the concentration of combined protein extracts was performed using ultrafiltation membrane instead of concentration under vacuum. Temperature and pH during ultrafiltration was kept at 50° C. and pH 9-11 in order to avoid possible heat or acid precipitation of proteins and clogging of the membrane.

Protein content of the product obtained from second trial was at 83.7% and the amino acid content was 80.2% (Tables 2 and 3) indicating the advantage of using membrane ultrafiltration technique to obtain much purer protein concentrate, and by washing off other nitrogen-containing impurities. Ash content or salts present in DF Picolo-PTP-2 was also less. The PDI of DF Picolo-PTP-2 was 76.9%, much higher than the PDI of DF Picolo-PTP-1 from Trial-1. This can be due to less protein aggregation that is common during acid precipitation and greater interaction of polypeptide chains with the water.

Further extraction studies were performed using a 10 kDa membrane (instead of the 5 kDa membrane of this Example). The 10 kDa membrane in the ultrafiltration step also produced a higher purity protein isolate (92.6% for DF-Picolo), versus the 5 KDa membrane DF Picolo-PTP-2 product of Table 2 below. Higher purity of protein (>75%) is preferred for encapsulation with hemp protein to obtain the desired functionality and nutritional value of the resultant oil powder.

TABLE 2
Yield, PDI, composition of hemp seeds, meals and proteins from
pilot scale

| | Result | | | | |
|---|---|---|---|---|---|
| | | NDF | | DF | |
| | Picolo-PT | Picolo | DF Picolo | Picolo | DF Picolo |
| | Seeds | PT-meal | PT meal | PTP-1 | PTP-2 |
| Yield (%) | | | | 9.72 | 7.53 |
| PDI (%)* | | N/A | N/A | 10.2 | 76.9 |
| Protein | 24.5 | 31.4 | 44.8 | 81.9 | 83.7 |
| (Nx6.25, %) | | | | | |
| Oil content by | 31.2 | 9.43 | 0.14 | 0.19 | 0.29 |
| Swedish tube | | | | | |
| (%,) | | | | | |
| Moisture (%) | 5.8 | 8.35 | 4.24 | 5.06 | 5.95 |
| Ash (%) | 4.96 | N/A | 7.64 | 11.1 | 5.65 |
| Carbohydrate | 33.6 | N/A | 43.2 | 1.75 | 4.41 |
| (%, calculated) | | | | | |

*PDI = Protein Dispersibility Index,
NDF = non-defatted,
DF = defatted,
N/A = Not analyzed

Amino acid composition of DF Picolo-PTP-2 had significantly high amount of aspartic acid and glutamic acid, and higher content of sulfur containing amino acids (cysteine and methionine) compared to the DF Picolo-PTP-1 which can affect functional and nutritional characteristics. When the amino acid scores were calculated based on FAO/WHO/UNU pattern of amino acid requirements for preschool children (2-5 yrs age) (Joint FAO/WHO/UNU Expert consultation, 1985, WHO Tech. Rept. Ser. No. 724, WHO, Geneva, Switzerland), sulfur containing amino acids were the limiting amino acids in DF Picolo-PTP-1, whereas lysine was the limiting amino acid in both defatted meal and DF Picolo-PTP-2 (Table 4). Scores of 1.0 or greater indicate that the specific amino acid is not limiting relative to requirements. Previous reports also indicated that lysine is the first limiting amino acid in several hemp seed, nut, and flour sources tested (House, 2010). Overall, DF Picolo-PTP-2 is a great source of essential amino acids.

TABLE 3
Amino acid composition of hemp meal and proteins from pilot
scale

| | DF Picolo- | DF Picolo- | DF Picolo- |
|---|---|---|---|
| Amino acid | PT meal | PTP-1 | PTP-2 |
| Aspartic acid | 3.39 | 2.44 | 8.75 |
| Glutamic acid | 5.99 | 8.06 | 16.23 |
| Serine | 1.99 | 5.33 | 4.76 |
| Glycine | 1.48 | 4.11 | 3.57 |
| Histidine | 0.99 | 2.93 | 2.74 |
| Arginine | 3.79 | 12.12 | 10.63 |
| Threonine | 0.93 | 2.41 | 2.30 |
| Alanine | 1.39 | 3.86 | 3.21 |
| Proline | 1.43 | 4.03 | 3.21 |
| Tyrosine | 0.98 | 3.00 | 2.64 |
| Valine | 1.72 | 3.91 | 3.77 |
| Methionine | 0.92 | 0.45 | 1.82 |
| Cystine | 0.89 | 0.28 | 1.50 |
| Isoleucine | 1.23 | 3.22 | 3.16 |
| Leucine | 2.17 | 6.09 | 5.14 |
| Phenyl alanine | 1.50 | 4.17 | 3.47 |
| Lysine | 1.23 | 2.21 | 2.47 |
| Tryptophan | 0.32 | 0.86 | 0.84 |
| Total amino acids | 32.35 | 69.46 | 80.20 |

TABLE 4
Amino acid scores of hemp meal and protein products

| Amino acid | DF Picolo-PT meal | DF Picolo-PTP-1 | DF Picolo-PTP-2 |
|---|---|---|---|
| Histidine | 1.61 | 2.22 | 1.80 |
| Threonine | 0.85 | 1.02 | 0.84 |
| Valine | 1.52 | 1.61 | 1.34 |
| Met + Cys | 2.24 | 0.42 | 1.66 |
| Isoleucine | 1.36 | 1.66 | 1.41 |
| Leucine | 1.02 | 1.33 | 0.97 |
| PA + Tyr | 1.22 | 1.64 | 1.21 |
| Lysine | 0.66 | 0.55 | 0.53 |
| Tryptophan | 0.90 | 1.13 | 0.95 |

Protein functionality of the two protein powders were also evaluated compared to some commercial proteins and the results are shown in Table 5. Lower water hydration capacity was observed for two hemp proteins compared to commercial proteins. Protein solubility was also limited compared to commercial proteins. However, they formed very stable and firm gels when heated to high temperature (95° C., 1 hr) with water at different concentrations. Least gelation concentration (amount of protein needed to make a firm gel) of DF Picolo-PTP-1 was 10% whereas least gelation was achieved at 8% concentration with DF Picolo-PTP-2. Defatted hemp meal was also tested and it showed a least gelation concentration of 10%. A control soy protein isolate (86.7% protein) tested for minimum gelation under the same conditions needed about 19% concentration (wt. of protein in water) to make a gel indicating the high gelation properties of hemp protein isolates made during this study. Malomo et al. (2014) reported least gelation concentration of 12% and 22%, respectively, for a defatted hemp meal used (44.3% protein) and protein isolate made by isoelectric precipitation (84.1% protein) during their study.

Interestingly, emulsion capacity of DF Picolo-PTP-1 at 1% concentration (pH 7.0) was higher than DF Picolo-PTP-2 and the commercial proteins tested. This can be due to its hydrophobic nature by opening up aromatic residues during protein denaturation. However the emulsion formed using DF Picolo-PTP-2 was a stable emulsion, compared to the emulsion made with DF Picolo-PTP-1. Emulsion stability is an important parameter determining the encapsulation efficiency and stable oil powder production. Oil holding capacity of DF Picolo-PTP-1 was about 0.9 g oil/g protein. Poor foaming capacity and stability was observed for both hemp proteins at 1% concentration at pH 7.0.

Functional properties of proteins are dependent on their solubility and hydrophobic/hydrophilic characteristics. Malomo et al. (2014) reported similar observations that hemp proteins prepared using isoelectric precipitation had poor foaming, solubility and emulsification capacities at neutral pH. They reported that lower pH (˜pH 3.0) increased the solubility and provided more structure to hemp proteins so that the functional properties such as foaming capacity increased. They also reported concentration dependency of the hemp protein where at higher concentration the foaming capacity of hemp proteins reduced due to reduced flexibility of protein structure (i.e., crowded solution) but the emulsification capacity and stability increased at higher concentration due to strong protein-protein interactions at the oil-water interface. Further, Yin et al., 2009, reported the ability of increasing solubility, emulsifying capacity, and in vitro trypsin digestibility of hemp proteins through structural modification (i.e., succinylation).

During this work, emulsifying and foaming capacities of DF Picolo-PTP-2 was studied also at pH 4.5, at the isoelectric point, to assess how this affects the functionality as Malomo et al. (2014) reported. Results are shown Table 5. While emulsifying capacity increased at this pH and protein concentration and it was better than soy and pea protein commercial samples tested, the foaming capacity decreased and the emulsion stability fell below 90% at this isoelectric pH. These observations are different from what was reported by Malomo et al. (2014) where the foaming capacity and solubility increased at lower pH. In the case of utilizing hemp protein as an encapsulation carrier, good dispersibility in the aqueous phase, ability to stay at the water-oil interface, emulsification capacity and emulsion stability, and also ability of protein to hold oil after encapsulation are important functional requirements.

Similar to the protocol followed by Yin et al., 2009, DF Picolo-PTP-2 protein was succinylated and the emulsification capacity increased to 205 g oil/g protein and the emulsion stability was 100%. Protein solubility was also increased at pH 7-10 (Table 5).

TABLE 5
Protein functionality results for hemp protein encapsulated
powders and some commercial protein samples*

| | | | DF | DF | | | |
|---|---|---|---|---|---|---|---|
| | DF | DF | Picolo-PTP-2 | Picolo-PTP-2 | Whey | Soy | Pea |
| | Picolo-PTP-1 | Picolo-PTP-2 | (pH 4.5)* | Succinylated** | protein | protein | protein |
| PDI*** | 10.2 | 76.9 | | | | | |
| Protein (N × 6.25, %) | 81.9 | 83.7 | 83.7 | 93.8 | 88.0 | 87.2 | 81.7 |
| Water hydration capacity | 2.0 | 2.3 | | N/A | 9.2 | 3.1 | 4.1 |
| (g water/g protein) | | | | | | | |
| Oil holding capacity | 0.9 | 1.0 | | N/A | 1.5 | 1.0 | 1.2 |
| (g oil/g protein) | | | | | | | |
| Emulsification | 228 | 98 | 208 | 205 | 210 | 103 | 155 |
| capacity (g oil/g protein) | | | | | | | |
| Emulsion stability (%) | 32 | 96 | 87 | 100 | 98 | 100 | 98 |
| Foaming capacity (%) | 20 | 28 | 13 | N/A | 91 | 220 | 130 |
| Foam stability (%) | 0 | 0 | 0 | N/A | 74 | 60 | 77 |
| Protein solubility (%) | | | | | | | |
| pH 2.0 | 16 | 59 | | 39 | 103 | 25 | 55 |
| pH 4.0 | 9 | 19 | | 14 | 100 | 15 | 11 |
| pH 5.0 | | | | 15 | 102 | 17 | 11 |
| pH 6.0 | 9 | 20 | | | | | |
| pH 7.0 | | | | 65 | 102 | 30 | 36 |
| pH 8.0 | 12 | 21 | | | | | |
| pH 10.0 | 18 | 33 | | 68 | 99 | 55 | 54 |

*Emulsifying and foaming capacities were measured using a 1% protein solution at pH 7.0 for all proteins tested. Only for DF Picolo-PTP-2, these properties were also measured at pH 4.5 using a 1% protein solution.
**Succinylation of protein using method of Yin et al, 2009
***PDI = Protein Dispersibility Index,
N/A = Not analyzed

### Example 2

### Hemp Oil Encapsulated Powders Production and Quality Testing Initial Lab-Scale Work with DF Picolo-PTP-1 and DF Picolo-PTP-2

Even though the surface oil content were similar at 30, 40 and 50% oil loading with the oil powders made using two different hemp proteins (note that the oil powders were made using protein-polysaccharide combination during this testing), the recovery of oil powder with DF Picolo-PTP-2 was much higher compared to that of DF Picolo-PTP-1 (Tables 6 and 7). This can be due to the difference in encapsulation efficiency due to the PDI, solubility, emulsion stability as well as amino acid composition differences discussed above. The pH selected for emulsion preparation for encapsulation work was pH 8.0, as preliminary trials indicated this pH produced a better and more stable emulsion when using hemp seed protein fraction (together with the polysaccharide) and hemp oil. The PDI of DF Picolo-PTP-2 was high and it contained higher amounts of aspartic and glutamic acid (Table 3) which can act as anionic surfactants. Both protein powders have high amount of arginine, which can act as a cationic surfactant. It is interesting to note that even though the protein functionality data indicate that DF Picolo-PTP-1 could act as a better emulsifier in phosphate buffer-corn oil mixture (pH 7.0) at 1% protein concentration compared to DF Picolo-PTP-2, the functionality of DF Picolo-PTP-1 is quite different in this hemp oil-protein-polysaccharide matrix at much higher protein concentration (˜30-35%), together with another carrier. Although the DF Picolo-PTP-1 fraction had a higher emulsion capacity, the poor emulsion stability (32%, Table 5) and PDI were problematic. As noted above, this is believed to be due to the high temperature used in the concentrating steps of the underlying extraction.

TABLE 6
Spray dried hemp oil powder recovery (%) at different oil loading

| Sample ID | 50% oil load | 40% oil load | 30% oil load |
|---|---|---|---|
| Oil:Protein powder | 1.6:1 | 1.1:1 | 0.7:1 |
| DF Picolo-PTP-1 | 38.59 | 23.89 | 49.33 |
| DF Picolo-PTP-2 | 53.8 | 55 | 59.4 |

TABLE 7
Surface oil content (%) of hemp oil powder at different oil loading

| Sample ID | 50% oil load | 40% oil load | 30% oil load |
|---|---|---|---|
| DF Picolo-PTP-1 | 2 | 1.6 | 1.3 |
| DF Picolo-PTP-2 | 2 | 1.4 | 1.2 |

Hemp Oil Encapsulation with Hemp Protein Alone and Hemp Protein with Polysaccharide

a) Particle Size Variation with Hemp Oil Loading and Wall Material Combination

Oil powder particle size distribution depends on various factors such as initial emulsion stability, wall material composition, nature of oil, oil loading in the dry powder, processing parameters at emulsion preparation stage and spray drying conditions. Four selective spray dried powders were chosen to compare and study the oil powder particle size distribution depending on hemp oil loading and wall material composition. Oil loading was done at 30% and 50% (w/w). At both oil loading level, hemp oil powders were prepared using only DF Picolo-PTP-2 or using a combination of DF Picolo-PTP-2 and polysaccharide blend as explained in the methodology section.

The 50% hemp oil microencapsulated powder with only DF Picolo-PTP-2 hemp seed protein fraction as the wall material showed wider particle size distribution than 50% hemp oil microencapsulated powder with DF Picolo-PTP-2 hemp seed protein fraction and polysaccharide as the wall material (FIGS. 4 and 5). The wider particle size distribution (PSD) for the hemp protein microcapsules indicated some non-uniform particles probably due to higher surface oil which caused agglomeration of the microcapsules.

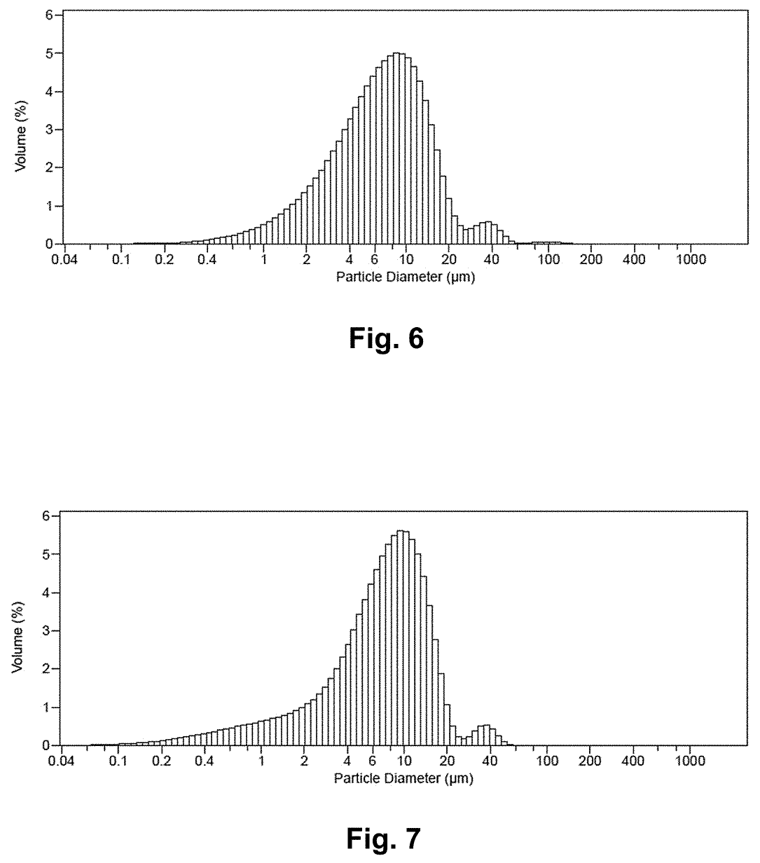

The mean diameter of the spray dried powder with only DF Picolo-PTP-2 was close to 19 μm, whereas mode of distribution was at 9 μm. The mean diameter of the spray dried powder made with both the hemp protein and polysaccharide was close to 11 μm whereas mode of distribution was at 10 μm. Smaller mean diameter of the powder indicates better powder quality. Results indicated that large particles or particle agglomerates present in powder made with hemp protein fraction alone was more than that of the powder with hemp protein and polysaccharide (FIGS. 6 and 7) at lab-scale. A narrow particle size distribution can be seen for the powder with polysaccharide indicating that hemp protein in combination with polysaccharide has better microencapsulation efficiency than only hemp protein at this high hemp oil load (50%, w/w).

When tested at 30% (w/w) oil loading, the mean diameter of the spray dried powder made only with DF Picolo-PTP-2 was close to 9 μm, whereas mode of distribution was at 8.5 μm. The mean diameter of the spray dried powder with maltodextrin at 30% oil load was close to 8.4 μm, whereas mode of distribution was at 9 μm, showing that the PSD for both single and with maltodextrin powder were very comparable at this oil loading level.

Microcapsules were prepared containing 40% (w/w) hemp oil coated with DF Picolo-PTP-2 protein fraction as well as another microcapsule product of 40% hemp oil coated with the Df Picolo-PTP-2 protein fraction and polysaccharide (i.e., maltodextrin) blend. The recovery of 40% hemp oil microencapsulated powder with only hemp protein was 40%. Moisture content of the powder was 1.4% and surface oil was about 6.6%. Recovery of the final 40% hemp oil microencapsulated powder with hemp protein and polysaccharide combination was 44%. Moisture content of the powder was 1.9% and surface oil was about 1.5%. These results indicate that use of only hemp protein as the carrier is sufficient to reach comparable oil powder recovery as with a polysaccharide, however, the surface oil content seemed to be higher confirming the usefulness of polysaccharide. Since it is desirable to use only protein as the carrier to reduce processing cost and to reduce calories from the polysaccharide in potential food applications, a pilot plant scale microencapsulation trial was conducted using only the DF Picolo-PTP-2 protein fraction as the wall material.

b) Confocal Laser Scanning Microscopy

Hemp oil emulsion was prepared by staining the oil phase and aqueous phase with Nile Red and Fast Green FCF fluorescence dyes, respectively. A freshly prepared emulsion sample stained with dyes was diluted with water to get a good contrast and clarity under the microscope. Stained spray dried powder dispersed in water was also taken as is on the glass slide for study. Adjusting laser filter matching to the specific dye, final micro structural pictures were captured. In representation, the green color zone was selected for highlighting oil phase, whereas red color zone was for protein and/or protein-polysaccharide or protein-maltodextrin zone. Confocal images are not shown. When Fast green FCF dyed protein-polysaccharide zone was in focus (red color), the image indicates that hemp oil droplet (visualized in dark spot) is embedded either within only hemp protein matrix or protein-polysaccharide matrix used.

At 30% (w/w) oil loading, the oil was well imbedded within the carrier matrix in both cases, but the particle size and structure were different. The image for 30% hemp oil showed the appearance of droplets in the emulsion using protein-maltodextrin matrix before spray drying, whereas the image without maltodextrin showed the appearance of oil powders when dispersed in water after spray drying. In both cases, it showed again that oil was encapsulated within the protein-maltodextrin matrix. Also, differences could be seen in particles size and microstructure of oil powders when maltodextrin or the other polysaccharide carrier (Crystal TEX-MiraMist polysaccharide combination) was used for encapsulation purpose alone with hemp protein.

For 40% (w/w) loading, and comparing protein powders with hemp protein alone, versus with polysaccharide, thickness of coating with only protein seemed low as expected, and previous surface oil content analysis also showed higher surface oil (˜6.6%) for hemp protein alone, compared to 1.5% for powders including the polysaccharide. However, microscopy images confirmed that hemp protein alone is also an effective encapsulating agent. Even at 50% (w/w) oil loading, powders with hemp protein alone indicated that the oil was well incorporated (encapsulated) into the protein matrix. Thus, the pilot scale encapsulation trial used only DF Picolo-PTP-2 protein as the carrier and at 50% (w/w) oil loading level.

c) Scanning Electron Microscopy (SEM)

The morphology of the spray-dried microparticles suspended in water at appropriate dilution was observed with a scanning electron microscope (SEM, S-2500, Hitachi, Tokyo, Japan) operating at 15 kV as described by Wang et al. (2011). The powders were also fractured carefully after frozen in liquid nitrogen, and the interior morphology of the microparticles was studied and photographed using the SEM (Xu et al., 2007).

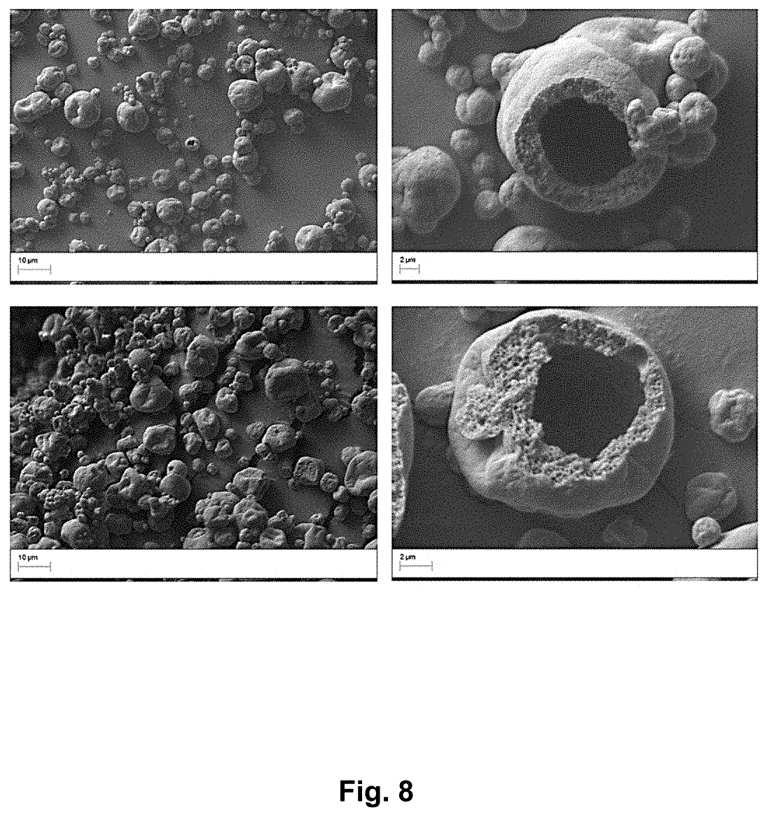

SEM image data confirmed how well the oil is entrapped inside oil powder particles (FIG. 8). The powder made using only hemp seed protein fraction had a smoother surface compared to the protein-polysaccharide combination, whereas the latter had a much thicker layer around the oil droplets as expected.

d) Encapsulation Efficiency (EE) and Loading Efficiency (LE)

The method described by Beaulieu et al. (2002) was used to extract the oil from the microencapsulated powdered oil. The encapsulation efficiency (EE) and loading efficiency (LE) were calculated by the following equations:

EE (%)=W_{encapsulated oil}/W_{total oil}×100; where W_{encapsulated oil} represents the weight of oil encapsulated in the microparticles and W_{total oil} represents the oil added initially in the particle formation mixture.

LE (%)=W_{encapsulated oil}/W_{microparticles}×100; where W_{microparticles} represents the weight of the microparticles encapsulating the oil inside.

Oil payload measured as EE (%) and LE (%) also confirmed the encapsulation efficiency of DF PTP-2 protein alone or in combination with a polysaccharide carrier up to 50% (w/w) oil payload (Table 8). Inclusion of a polysaccharide helped to improve EE and LE at a higher oil load.

TABLE 8
Microencapsulation efficiency and loading efficiency of oil
powders

| | % | % Loading |
|---|---|---|
| | Encapsulation | Efficiency |
| Sample | efficiency (EE) | (LE) |
| 30% hemp oil microencapsulated powder | 86.7 | 26.02 |
| with DF PTP-2 hemp protein only | | |
| 40% hemp oil microencapsulated powder | 90.7 | 36.27 |
| with DF PTP-2 hemp protein only | | |
| 50% hemp oil microencapsulated powder | 81.8 | 40.92 |
| with DF PTP-2 hemp protein only | | |
| 50% hemp oil microencapsulated powder | 89.74 | 44.87 |
| with DF PTP-2 hemp protein and | | |
| polysaccharide combination | | |

Pilot Scale Encapsulation with DF Picolo-PTP-2

At pilot scale, microencapsulation of 50% (w/w) hemp oil with DF Picolo-PTP-2 hemp seed protein fraction produced a nice free flowing dried powder with 76.5% powder recovery from the starting materials (i.e., total weight of protein and oil) used. The powder when analyzed within 24 hrs for the surface oil content resulted in only 1.0% showing the effectiveness of encapsulation. The bulk density of powder was 0.39 g/ml with 0.8% moisture. Oil powder had a bland taste and was easily dispersible in water. These results also confirmed the ability of hemp protein isolate made using alkaline extraction followed by ultrafiltration technique to act as an encapsulation agent without using of any other polysaccharide source as the carrier.

a) Particle Size Distribution

Particle size distribution profile of the pilot scale spray dried powder was evaluated. The mean diameter of the spray dried powder was close to 16 μm, whereas mode of distribution was at 18 μm.

b) Oxidative Stability Testing at Ambient and Accelerated Storage

Hemp oil was extracted from the encapsulated powder to study possible degradation of hemp oil due to high pressure homogenization during emulsion formation followed by temperature exposure during spray drying. Results for Week-0 (i.e., at the start of oxidative stability testing) in Table 9 indicated that encapsulated hemp oil did not degrade or oxidize during processing. It was in fact interesting to note that compared to RB oil, the oil extracted from hemp oil powder and analyzed for peroxide value (PV) and anisidine value (p-AV) resulted in lower numbers by week-0 (PV=15.5 meq/kg and p-AV=0.99). This can be due to possible free radical scavenging/binding ability of amino acids present in hemp protein.

The RB hemp oil which had been stored at ambient temperature for about five months before using for encapsulation process had higher PV (21.7 meq/kg) and p-AV of about 4.3 (Table 9). Even though the PV and p-anisidine values did not show a drastic increase during ambient storage of RB hemp oil for two months during the stability testing, it decreased significantly during the accelerated storage at 65° C. indicating the formation of secondary oxidation products. This was confirmed by significant increase in p-anisidine value for RB oil at 65° C. The free fatty acid content of RB oil, an indication of hydrolytic rancidity of oils during storage, did not increase significantly during ambient or accelerated storage. Generally, sample storage at 65° C. for a day is equivalent to about one-month storage at ambient temperature during shelf life studies.

Different from RB oil alone, the encapsulated oil PV increased with storage time both at ambient and at 65° C. indicating that the encapsulated oil was protected and was mainly at the primary oxidation period during this time. The PV value of encapsulated oil started decreasing by week-8 of the accelerated storage. The p-anisidine values did not show a significant increase during the ambient storage again confirming the fact the oil was still mainly at primary oxidation stage, whereas the p-anisidine values increase with storage time at 65° C. Similar to the RB oil, encapsulated oil also did not show a significant increase in FFA during the 2-month stability study.

Overall, oxidative stability testing data indicated the ability of hemp protein to protect the unsaturated RB hemp oil from oxidation when it was encapsulated at 50% level.

TABLE 9
Oxidative stability of RB hemp oil and encapsulated hemp oil powder*

| | | PV (meq/Kg) | | p-Anisidine | | FFA (%) | |
|---|---|---|---|---|---|---|---|
| Sample | Timeline | Ambient | 65° C. | Ambient | 65° C. | Ambient | 65° C. |
| RB | Week 0 | 21.7 | 21.7 | 4.3 | 4.3 | 0.17 | 0.17 |
| hemp | Week 1 | 21.2 | 15.9 | 4.4 | 9.8 | 0.17 | 0.18 |
| oil | Week 2 | 21.4 | 13.2 | 4.67 | 13 | 0.17 | 0.2 |
| | Week 4 | 23 | 10.8 | 4.24 | 16.4 | 0.16 | 0.18 |
| | Week 8 | 20.1 | 6.16 | 4.62 | 20.4 | 0.19 | 0.23 |
| Hemp | Week 0 | 15.5 | 15.5 | 0.99 | 0.99 | 0.15 | 0.15 |
| oil | Week 1 | 15 | 22 | 0.69 | 2.12 | 0.15 | 0.12 |
| powder | Week 2 | 14.2 | 23 | 1.01 | 7.38 | 0.1 | 0.13 |
| | Week 4 | 18.3 | 25.8 | 0.87 | 8.77 | 0.05 | 0.1 |
| | Week 8 | 20.9 | 13 | 1.16 | 13.7 | 0.13 | 0.23 |

*Mean values from duplicate analysis with standard error within 3%.
PV = Peroxide value,
FFA = Free fatty acids

### Example 3

### Protein Production Using Hemp Meal and Acid Precipitation for Oil Powder Production

a) Protein Preparation

About 5.0 kg of hemp seeds from a different variety, X-59, to that used in Example 1 was pressed using a lab press (IBG Monforts Oekotec GmbH & Co. KG, Germany) to expel oil. To make defatted meals, press cakes were extracted with hexane (1:4, w/v) for 3.5 hrs using a Soxhlet extractor to recover the remaining oil. Hexane was removed under vacuum at ˜50° C. using a rotary evaporator and the solvent extracted oil was combined with the respective crude pressed oil (filtered) to produce the final crude hemp oil for further work. Meal left after solvent extraction was kept at ambient temperature to remove residual hexane, vacuum dried at 50° C., and used for the protein extraction work.

Both defatted (DF) and non-defatted (NDF) meals were milled to fine powders (>70% through the #50 US mesh) using a hammer mill (Jacobson Machine works Inc., MN, USA, Model P-66-B) followed by a pin mill (Retsch GmbH & Co., Germany, Model 2M1). The milled powders were analyzed for proximate composition.

Hemp meal slurry using DF or NDF meals was prepared by mixing 500 g milled hemp powder with 5× of water. The protein extraction was conducted by adjusting pH to 11.0 using 50% NaOH, and mixing for 2 hrs at 50° C., as shown in FIG. 9. Extraction was repeated for another 1 hr by adding 2 parts (w/w) of water to the spent solids obtained from the first extraction. The combined supernatant after extraction was adjusted to pH 5.0 using 85% phosphoric acid and centrifuged to recover acid precipitated protein curd. The pH of protein curd, slurried in water at about 10% solid content, was adjusted to pH 7.0 using 50% potassium hydroxide and the slurry was spray dried to produce the protein powders. These proteins were labelled as DF X-59-IEP and NDF X-59-IEP.

Proximate composition of X-59 seeds were 22.9% protein (N×6.25), 29.7% oil, 8.60% moisture, 3.77% ash, and 35.0% carbohydrates. Pressing of seeds at lab scale produced press cakes with an average residual crude oil content of 7.50%. Press cake after milling and sieving to remove ˜25-30% hull fraction contained about 41.5% protein (N×6.25), 9.17% oil, and 8.62% moisture. Defatted meal was at 49.1% protein (N×6.25), <0.10% oil, and 6.01% moisture.

Yield and composition of proteins produced from NDF and DF milled press cake are shown in Table 10. Considering the amino acid profiles, total amino acids in DF X-59-IEP and NDF X 59-IEP were 87.1, and 76.1%, respectively. Similar to the proteins prepared in Examples 1, this indicates the presence of non-protein nitrogen compounds in the IEP proteins. Protein prepared using NDF press cake at laboratory scale contained about 8.72% residual oil.

Amino acid scores of proteins are shown in Table 11. Limited amino acid is lysine in both proteins. Compared to DF PTP-1 protein (Example 1) where the acid precipitation of protein was done after a pre-concentration step using a vacuum evaporation, the DF X-59-IEP protein with minimal heat exposure produced a protein with higher content of sulfur containing amino acids (Cys and Met). Emulsion stability of the acid precipitated proteins in this example was 94-96%, showing better functionality compared to DF PTP-1. For example, EC of NDF X-59-IEP was 198 g oil/g protein and ES was 96%.

TABLE 10
Yield and purity of the proteins prepared from defatted and
non-defatted hemp meals and acid precipitation method

| | DF X-59-IEP | NDF X-59-IEP |
|---|---|---|
| Yield (%) | 19.3 | 22.7 |
| Protein (Nx 6.25, %) | 95.5 | 83.3 |
| Oil content by Swedish tube (%,) | <0.1 | 8.72 |
| Moisture (%) | 4.52 | 3.34 |

TABLE 11
Amino acid scores of hemp protein products

| Amino acid | DF X-59 IEP | NDF X-59 IEP |
|---|---|---|
| Histidine | 1.42 | 1.00 |
| Threonine | 0.65 | 0.53 |
| Valine | 1.33 | 1.17 |
| Met + Cys | 1.87 | 2.05 |
| Isoleucine | 1.39 | 1.34 |
| Leucine | 0.98 | 0.96 |
| PA + Tyr | 1.28 | 1.21 |
| Lysine | 0.43 | 0.46 |
| Tryptophan | 1.13 | 2.03 |

b) Oil Powder Production

The DF X-59-IEP and NDF X-59-IEP proteins were used in making hemp oil powders at 50% (w/w) oil load using the method described in Example 2. With the NDF proteins, oil content added to obtain 50% (w/w) oil load was adjusted based on the residual oil content of the protein powder. The pH during emulsion preparation was set at pH 6.0. Microencapsulation and loading efficacy of oil powders were tested as described in Example 2. A control soy protein sample was also used in making hemp oil powders. The pH for stable emulsion formation with the soy protein was at pH 7.0, and therefore this was the selected pH for oil powder production.

Results indicate that defatting of press cake is not essential in producing hemp protein for hemp oil encapsulation work. In fact, NDF X-59-IEP was more efficient and had higher microencapsulation and oil loading efficiencies (Table 12). Hemp proteins showed better encapsulation efficiency compared to the soy protein control tested.

TABLE 12
Microencapsulation efficiency and loading efficiency of
oil powders

| | % Protein | % | % |
|---|---|---|---|
| | purity | Encapsulation | Loading |
| Oil powder | (Nx 6.25) | efficiency | Efficiency |
| 50% RBD Hemp oil/ | 99.9 | 87.8 | 43.89 |
| DF X-59-IEP | | | |
| 50% RBD Hemp oil/ | 85.2 | 89.6 | 46.33 |
| NDF X-59-IEP | | | |
| 50% hemp oil/ | 87.2 | 85.4 | 42.70 |
| ADM ARDEX-F-DSP | | | |
| (soy protein) | | | |

### Example 4

### Microencapsulation Trials with Hydrolyzed Hemp Proteins

A portion of the NDF X-59-IEP protein curd prepared during Example 3 was suspended in water and hydrolyzed at pH 7.0, 50° C. with 0.2% (w/w protein) Bromelain for 1 hr. The enzyme was inactivated by heating >80° C. for 5 min and the slurry was spray dried to make the protein powder. Solubility of the proteins at selected pH were tested and the results are shown in Table 13. The method described in Example 2 was used in making oil powders.

Solubility of non-hydrolyzed proteins was at about 25±3% range for pH 3-7 (Table 13). With partial hydrolysis of proteins, solubility increased to about 51-54%. The EC of non-hydrolyzed and partially hydrolyzed proteins were 198 g oil/g protein and 208 g oil/g protein, respectively. The ES values were 96% (non-hydrolyzed) and 84% (hydrolyzed). Partial hydrolysis reduced the ES, but it still was above 80% and worked effectively in encapsulating hemp oil. In fact, the encapsulation efficiency and loading efficiency increased with the use of partially hydrolyzed proteins (Table 14). This can be due to a combination of several factors such as increased solubility, exposing amino acid chains that are useful for better interaction with the non-polar oil phase, while still maintaining the stable oil-in-water emulsion for encapsulation.

TABLE 13
Solubility of partially hydrolyzed and non-hydrolyzed hemp
protein powders at different pH

% Solubility

| | NDF X-59-IEP | NDF X-59-IEP- |
|---|---|---|
| pH | hemp protein | Hydrolyzed hemp protein |
| 3.0 | 27.0 | 52.2 |
| 6.0 | 22.5 | 51 |
| 7.0 | 24.8 | 54 |

TABLE 14
Microencapsulation efficiency and loading efficiency of
oil powders - Use of hydrolyzed and non-hydrolyzed hemp
proteins for encapsulation

| | % Microencapsulation | % Loading |
|---|---|---|
| Oil powder | efficiency | Efficiency |
| 50% hemp oil with NDF X-59-IEP | 89.6 | 46.33 |
| hemp protein | | |
| 50% hemp oil with NDF X-59- | 93.1 | 48.14 |
| IEP-Hydrolyzed hemp protein | | |

### Example 5

### Microencapsulation Trials with Hemp Protein (DF PTP-2) and Different Oils at 50% (w/w) and 70% (w/w) Oil Loading Level

The method described in Example 2 was used in preparing oil powders with DF PTP-2 hemp seed protein fraction and using various types of oils including hemp seed oil, microalgal oil, high MCT (medium chain triglyceride) oil, flax oil, canola oil and tuna oil at 50% (w/w) and 70% (w/w) oil loading as shown in Table 15.

Overall, the microencapsulation efficiency was above 80% for all the oil types tested. Hemp protein microencapsulated the algal oil and coconut MCT oil very well. Even at 70% oil load, MCT oil was microencapsulated well with about 64% oil loading (out of 70% total oil) in microparticles. With the other oils tested including hemp oil, the loading efficiency was at about 52-54% at 70% total oil loading (w/w).

TABLE 15
Microencapsulation efficiency and loading efficiency of
oil powders with different oils for encapsulation

| | Oil powder pH | % | % |
|---|---|---|---|
| | (i.e., pH at stable | Microencapsulation | Loading |
| Oil type/loading | emulsion formation) | efficiency | Efficiency |
| 50% Hemp oil | 6 | 81.8 | 40.92 |
| 50% Algal oil | 6 | 92.0 | 45.99 |
| 50% MCT oil | 3.0 | 89 | 44.48 |
| 50% Tuna oil | 4 | 84.9 | 42.46 |
| 70% hemp oil | 6 | 74.9 | 52.41 |
| 70% MCT oil | 3 | 91.1 | 63.79 |
| 70% Canola oil | 4 | 78.4 | 54.87 |
| 70% Tuna oil | 3 | 74.5 | 52.13 |
| 70% flax oil | 8 | 77.8 | 54.46 |

### Example 6

This example provides a comparison of a hemp protein extracted by prior art techniques, and the protein fractions of the present invention. The method described in Example 1 of the US Patent Publication No. 2018/0213818 A1 was used in extracting hemp protein using a X-59 hemp press cake and a 0.15 M calcium chloride solution (1:6, w/v). After 30 min hold at room temperature and recovering the protein extract through centrifugation, 1.5× water was added to the extract and pH was adjusted to 2.68 using 10% HCl. A 100,000 Dalton ultrafiltration membrane was used to concentrate and diafilter adding 5× water to the retantate. Diafiltered protein was spray dried to make the final product (labelled as BP).

The protein purity was assessed and SDS-PAGE under reducing conditions was performed using the method described in Malomo et al. (2014) to assess the molecular weights and composition of the protein product. Results were compared to the DF Picolo PTP-2 protein (Example 1).

The method described in Example 2 was used in preparing oil powders with the protein product at 50% (w/w) oil loading level. The pH during encapsulation was adjusted to 3.0. Resultant emulsion and oil powder quality was compared to the DF Picolo PTP-2 hemp protein-based oil powder.

Results:

The pH during initial extraction with 0.15 M calcium chloride was 5.8. The protein extract pH after removing insolubles and dilution as explained above was adjusted to 2.68 prior to concentration and recovery using the 100 kDa membrane. Protein purity of the BP product was 86.3%, with 5.97% moisture and 1.77% crude oil. Yield of the product was 3.7% from the starting hemp press cake, which was quite low.

The BP protein as extracted according to the patent description was then tested for ability to encapsulate oil. A pre-emulsion was prepared using BP protein during encapsulation with hemp oil at 50% oil load, but did not form stable emulsion when tested pH values of 3, 4, 5, 6, 7, and 8. The best result was at pH 3 in stabilizing the emulsion, but some precipitation could be observed even at this pH. Compared to the BP protein, emulsions prepared with DF Picolo PTP-2 protein fraction and hemp oil at 1:1 ratio (50% oil load) produced stable emulsions at pH 3, 6, 7, and 8. At pH 4 and 5 near the isoelectric point of the hemp protein, some oil-water phase separation could be observed with DF Picolo-PTP-2 protein. Encapsulated powder made with BP protein at pH 3 had 78.0% encapsulation efficiency with 39.4% oil loading efficiency. Encapsulated powder produced with the DF PTP-2 hemp protein fraction had 95.3% encapsulation efficiency with 47.6% oil load.

The SDS-PAGE results under reducing conditions indicated that the monomers of protein present in BP product is mainly below 20 kDa, majority close to the 10-15 kDa range. With DF Picolo-PTP-2 protein fraction, major monomeric protein bands were observed close to 20 kDa and 30-35 kDa indicating the presence of basic and acid subunits of edestin (20 kDa and 33 kDa, respectively, Mamone et al., 2019.). Presence of vicilin-like proteins (7S globulins, 48 kDa) was also clearly visible in DF Picolo PTP-2 protein fraction. A low intensity band for albumins (just below 20 kDa) was also observed in DF Picolo PTP-2, whereas this band was more intense in BP protein indicating the presence of more acid soluble proteins compared to more globular proteins present in DF Picolo PTP-2. These differences in protein composition and therefore viscosity and particle size of emulsions are expected to play a role in ability to serve as an effective emulsifying/encapsulating agent reaching to the oil-water interface and coating the oil droplets effectively to make stable emulsions.

Summary Comments from Examples

In summary, process conditions were developed and optimized at a laboratory scale first to prepare hemp protein concentrates and isolates using different hemp varieties. Selected protein fractions were used to conduct encapsulation trials to demonstrate the ability of alkaline extracted hemp seed protein fractions to form stable emulsions and to act as carriers to encapsulate hemp oil. The results indicated a great potential for these proteins to act as encapsulating agents, alone or in combination with polysaccharides to encapsulate hemp oil up to 50-70% oil load tested. Pilot scale work also proved the concepts of making hemp protein isolates and hemp oil powders identified at lab-scale. Stability test conducted showed the potential of hemp proteins to protect unsaturated hemp oil during storage.

Not only the encapsulated oil powders, but also hemp protein fractions and powders (concentrates and isolates) produced during this work can be used as food ingredients. Hemp oil as implicated from the results generated during this study is also high in alpha-linolenic acid (ALA) and gamma-linolenic acid (GLA) and has an ideal ratio of omega-3 to omega-6 fatty acids to be used for human nutrition. The products have wide application for food, beverage, cosmetic, and animal feed industries.

The use of hemp proteins in microencapsulating hemp oil and other oils is a unique value-added approach to increase the utilization of industrial hemp products. This aligns with the recent demand for hemp and hemp-derived products due to legislative changes for increased hemp product consumption. The hemp protein itself provides an alternative protein ingredient for specific food applications.

### INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention can be carried out using a large number of variations of the devices, device components, methods steps set forth in the present description. As will be obvious to one of skill in the art, methods and devices useful for the present methods can include a large number of optional composition and processing elements and steps.

Whenever a range is given in the specification, for example, a temperature range, a time range, a size range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### REFERENCES

Beaulieu, L., Savoie, L., Paquin, P., Subirade, M., 2002. Elaboration and characterization of whey protein beads by an emulsification/cold gelation process. Appl. Prot. Retinol. Biomacromol. 3, 239-248.
House, J. D., Neufeld, J., Leson, G., 2010. Evaluating the Quality of Protein from Hemp Seed (Cannabis sativa L.) Products Through the use of the Protein Digestibility-Corrected Amino Acid Score Method. J. Agric. Food Chem. 58, 11801-1180.
Leizer, Z., David, R., Alexander, P., Dushenkov, S., Raskin, I., 2000. The Composition of Hemp Seed Oil and Its Potential as an Important Source of Nutrition, J of Nutraceuticals, Functional and Medical Foods, 2(4), 35-53.
Malomo, S. A., He, R., Aluko, R. E., 2014. Structural and functional properties of hemp seed protein products. J. Food Sci. 79, C1512-C1521.
Malomo, S. A., He, R., Aluko, R. E., 2015. Conversion of a low protein hemp seed meal into a functional protein concentrate through enzymatic digestion of fibre coupled with membrane ultrafiltration. Innovative Food Science & Emerging Technologies, 31, 151-159.
Mamone et al., 2019. Food Res Int, 115, 562-571.
Nakhasi, D. K., Daniels, R. L., Corbin, D. N., Green, R. C., Microencapsulated oil product and method of making same, U.S. Pat. No. 9,332,774, issued May 10, 2016.
Schweizer M., Gosnell, B., Production of Soluble Protein Products From Hemp (“H701”), U.S. Patent Publication No. 2018/0213818 A1, published Aug. 2, 2018.
Wang, R., Tian, Z., Chen, L., 2011. Nano-encapsulations liberated from barley protein microparticles for oral delivery of bioactive compounds, International Journal of Pharmaceutics 406,153-162
Xu, X. D., Zhang, X. Z., Yang, J., Cheng, S. X., Zhuo, R. X., Huang, Y. Q., 2007. Strategy to introduce a indent micellar structure into poly(N-isopropylacrylamide) hydrogels. Langmuir 23, 4231-4236.
Yin, S-W., Tang, C-H., Wen, Q-B., Yan, X-Q., 2009. Functional and structural properties and in vitro digestibility of acylated hemp (Cannabis sativa L.) protein isolates. Int. J of Food Sci and Technol, 44, 2653-61.

1. A microencapsulated product of microcapsules, wherein the microcapsules comprise:
(a) a core comprising a lipid based component; and
(b) a coating comprising a hemp seed protein fraction obtained by alkaline aqueous extraction from a hemp seed protein source such that the hemp protein fraction is water soluble under alkaline conditions and is capable of forming a stable emulsion with the lipid based component.

2. The microencapsulated product of claim 1, wherein the hemp protein fraction is water soluble at a pH range of 8.5 to 11.5.

3. The microencapsulated product of claim 1, wherein the hemp protein fraction is water soluble at a pH range of 9 to 11.

4. The microencapsulated product of claim 1, wherein the hemp protein fraction has a molecular weight in the range of 5,000-500,000 Da.

5. The microencapsulated product of claim 4, wherein the hemp protein fraction has a molecular weight in the range of 10,000-500,000 Da.

6. The microencapsulated product of claim 1, wherein the hemp protein fraction for the coating is obtained by precipitating from an aqueous solution of the hemp seed protein source at or above an isoelectric pH of the hemp protein and at a temperature less than 70° C., or by ultrafiltration from an aqueous solution of the hemp seed protein source.

7. The microencapsulated product of claim 6, wherein the hemp protein fraction for the coating is obtained by precipitating from an aqueous solution of the hemp seed protein source at a pH in the range of 4.5-5.5, and at a temperature not greater than 60° C.

8. The microencapsulated product of claim 1, wherein the hemp protein fraction for the coating is modified by enzyme hydrolysis or succinylation.

9. The microencapsulated product of claim 1, wherein the coating further includes one or more carbohydrates selected from starch, modified starch, polysaccharides, maltodextrin, fibre, hydrocollids, gum arabic, gelan gum, carageenan, alginates, and lactates.

10. The microencapsulated product of claim 1, wherein the lipid based component is an edible oil, an essential oil, a wax or a flavour.

11. The microencapsulated product of claim 10, wherein the edible oil is derived from one or more of an oilseed crop, cereal crop, legume, algae, fish and yeast.

12. The microencapsulated product of claim 11, wherein the edible oil is derived from one or more of hemp seed, canola, flax, microalgal, soybean, oat, chickpea, camelina, coconut and fish.

13. The microencapsulated product of claim 1, wherein the lipid based component comprises greater than 30% by weight of the microencapsulated product in a dry powder form.

14. The microencapsulated product of claim 13, wherein the lipid based component comprises in the range of 35-75% weight of the microencapsulated product in a dry powder form.

15. A method of extracting a hemp protein fraction comprising:
a) providing a hemp seed protein source;
b) contacting the hemp seed protein source with an alkaline aqueous solution to extract hemp protein from the hemp seed protein source into an aqueous hemp protein solution;
c) separating the aqueous hemp protein solution from residual hemp protein source solids; and
d) isolating a hemp protein fraction by either:
i. precipitating hemp proteins from the separated aqueous hemp protein solution at or above an isoelectric pH of the hemp protein and at a temperature less than 70° C., and separating the precipitated proteins to produce the hemp seed protein fraction; or
ii. ultrafiltering the separated aqueous hemp protein solution to produce the hemp seed protein fraction having a molecular weight of 5,000 Da and higher.

16. The method of claim 15, wherein the pH of the extraction in step b) is in the range of 8.5-11.5.

17. The method of claim 16, wherein the hemp protein fraction is produced by step d, i) at a pH in the range of 4.5-5.5.

18. The method of claim 16, wherein the hemp protein fraction is produced by step d, ii).

19. The method of claim 16, wherein:
the hemp seed protein source is one or more of a defatted or non-defatted hemp seed, a hemp hull, and a defatted or non-defatted dehulled hemp meal;
the hemp seed protein source is optionally milled to a fine powder which is optionally screened prior to extraction; and
the hemp seed protein source is selected from the group consisting of Cannabis sativa, Cannabis indica, and Cannabis ruderalis, or the hemp seed protein source is from a variety of Cannabis sativa.

20. The method of claim 16, wherein the alkaline aqueous solution in step b) has a pH in the range of 9-11, and wherein the temperature during steps a), b) and c) is less than 70° C.

21. The method of claim 20, wherein the hemp protein fraction is produced by step d ii), and wherein the ultrafiltration is conducted with a selective membrane for 10,000 Da and higher, at a pH in the range of 9-11, and at a temperature during steps a), b) and c) is less than 70° C.

22. The method of claim 16, wherein the aqueous hemp protein solution is separated from the residual hemp protein source solids by centrifuging.

23. The method of claim 16, wherein the hemp protein fraction is further treated by one or more steps including diafiltration, washing, pasteurization, drying and spray drying.

24. The method of claim 1, further comprising:
e) forming a stable emulsion of the hemp seed protein fraction with a lipid based component.

25. The method of claim 24, further comprising:
f) drying the stable emulsion to form a microencapsulated product of microcapsules having a core comprising the lipid based component and a coating comprising the hemp seed protein fraction.

26. A hemp protein fraction for use in microencapsulating a lipid based component, wherein the hemp protein fraction is obtained by alkaline aqueous extraction from a hemp seed protein source such that the hemp protein is water soluble under alkaline conditions and is capable of forming a stable emulsion with the lipid based component.
